(19) United States
(12) Patent Application Publication
(10) Pub. No.: US 2012/0132707 A1
(43) Pub. Date: May 31, 2012

(54) VERIFYING LABELED DATE ON PACKAGING OF PRODUCT

(75) Inventors: Rong Zeng Cao, Beijing (CN); Feng Chun Wang, Beijing (CN); Hao Zhang, Beijing (CN)

(73) Assignee: International Business Machines Corporation, Armonk, NY (US)

(21) Appl. No.: 13/302,039

(22) Filed: Nov. 22, 2011

(30) Foreign Application Priority Data
Nov. 30, 2010 (CN) 201010577039.1

(51) Int. Cl. G06K 7/10

(52) U.S. Cl. 235/385

(57) ABSTRACT

An anti-forgery system and method for verifying labeled date on packaging of product. The system includes: a code generation device configured to generate one or more random codes associated with a date when the one or more random codes are generated; a storage device configured to store the one or more random codes and the date associated therewith; and a code distribution device configured to distribute the one or more random codes as a code to be printed with the labeled date on the packaging of the product. A method for verifying a labeled date on packaging of a product is also provided.

### CROSS-REFERENCE TO RELATED APPLICATION

This application claims priority under 35 U.S.C. §119 from Chinese Patent Application No. 201010577039.1 filed Nov. 30, 2010, the entire contents of which are incorporated herein by reference.

### BACKGROUND OF THE INVENTION

1. Field of the Invention

The invention relates to anti-forgery technology and, in particular, to a system and method for verifying labeled date on packaging of products.

2. Description of Related Art

It is an important issue concerning the consumer's interest to prevent the production date of a product or commodity from being faked. It is particularly important to prevent the production date from being faked for food and pharmaceuticals, etc. Food and pharmaceuticals have their respective quality guarantee periods. For example, it is required to print the production date and the quality guarantee period on the package of fresh milk to be sold in supermarkets for consumers' awareness. Consumers generally can buy the fresh milk with relatively near production date and consume the milk before the quality guarantee period is expired.

For a commodity using a specific package, the quality guarantee period of the commodity is fixed. The issue is that it is possible for illegal manufacturers to fake the production date in order to make the commodity look fresher. For example, if it needs a couple of days for delivering the bagged milk from the producing department to the supermarket, some illegal manufacturers can fake the production date of the bagged milk so as to extend the time they are be kept on the shelves in the supermarket. For example, the production date “2010-01-03” is printed on the milk bag on Jan. 1, 2010. The milk is filled into the milk bag on Jan. 2, 2010. As a result, the labeled date that can be seen by the consumer buying the bagged milk is one day later than the actual production date. Consumers have no way to identify whether the labeled date on the package is printed in advance. Illegal manufacturers can take advantage of the fact.

### SUMMARY OF THE INVENTION

One aspect of the present inventions provides a system for verifying a labeled date on packaging of a product, the system including: a code generation device configured to generate one or more random codes associated with a date when the one or more random codes are generated; a storage device configured to store the one or more random codes and the date associated therewith; and a code distribution device configured to distribute the one or more random codes as a code to be printed with the labeled date on the packaging of the product.

Another aspect of the present invention provides a method for verifying a labeled date on packaging of a product, the method including the steps of: generating one or more random codes associated with a date when the one or more random codes are generated; storing the one or more random codes and the date associated therewith; and distributing the one or more random codes as a code to be printed with labeled date on the packaging of the product.

Another aspect of the present invention provides a computer readable article of manufacture tangibly embodying non-transitory computer readable instructions which, when executed, cause a computer to carry out the steps of a method for verifying a labeled date on packaging of a product, the method including the steps of: generating one or more random codes associated with a date when the one or more random codes are generated; storing the one or more random codes and the date associated therewith; and distributing the one or more random codes as a code to be printed with labeled date on the packaging of the product.

### BRIEF DESCRIPTION OF THE DRAWINGS

The inventive features considered to be characterized of the invention are described in the Summary of Invention and the claims appended to the specification. However, the invention itself, its usages, other objectives, features and advantages can be better understood through reading the following detailed description of illustrative embodiments with reference to drawings.

FIG. 1 is an illustrative presentation of the block diagram of the system in accordance with one embodiment of the invention.

FIG. 2 is an illustrative presentation of the database record in accordance with one embodiment of the invention.

FIG. 3 is an illustrative presentation of the flow chart of the method in accordance with one embodiment of the invention.

### DETAILED DESCRIPTION OF THE PREFERRED EMBODIMENTS

Hereinafter, embodiments of the present invention will be described with reference to the accompanying drawings. In the following description, many specific details are illustrated so as to understand the present invention more comprehensively. However, it is apparent to the skilled in the art that implementation of the present invention can be practiced without these details. Additionally, it should be understood that the present invention is not limited to the particular embodiments as introduced here. On the contrary, any arbitrary combination of the following features and elements can be considered to implement and practice the present invention, regardless of whether they involve different embodiments. Thus, the following aspects, features, embodiments and advantages are only for illustrative purposes, and should not be construed as elements or limitations of the appended claims, unless otherwise explicitly specified in the claims.

Inventors believe there is a need to take technical measures to prevent the conduct of printing the production date on product packaging (product packaging) in advance, and thus propose a mechanism for verifying labeled date on packaging of product.

The system and method for the invention can be implemented by a third party (such as trade organizations, government quality supervision department) outside of the manufacture and the consumer, for instance, to provide service for producers and consumers. Producers can use the service for their product prestige. Consumers can use this service for verifying the production date of products.

For purpose of description, the meanings of several product-related dates as used in the specification of the invention are defined.

The term “production date”, or “date of manufacturing”, refers to the date when a product is actually manufactured.

The term “date of printing” refers to the date when the action of printing a date on product itself or packaging of product takes place. Depending on differences in products, the date can be printed directly on product itself (for example, solid chocolate), or on packaging of product (e.g., bag of bagged milk).

The term “labeled date” refers to date of manufacturing that is visible on the product itself or on packaging of product.

A labeled date is the result of date printing, and should reflect production date of product. If the labeled date is different from the production date, the labeled date can be deemed as a faked date.

It is technologically feasible to make the labeled date different from the production date. One possible practice is to print the date on the packaging of a product (labeled date) on some day (date of printing) earlier than the production date of the product. Taking bagged milk for example, a manufacturer predicts that one million bags of milk will be filled on Jan. 2, 2010 (production date). So the date “2010-01-03” (labeled date) is printed on one million empty bags in company with other messages such as produce batch number, as early as on Jan. 1, 2010 (date of printing). The instance 2 of the Table 1 below is a summary of the example.

TABLE 1

| | Date of | Production | | |
|---|---|---|---|---|
| Instance | printing | date | Labeled date | Remarks |
| 1 | Jan. 2, 2010 | Jan. 2, 2010 | Jan. 2, 2010 | Right practice |
| 2 | Jan. 1, 2010 | Jan. 2, 2010 | Jan. 3, 2010 | Date of printing |
| | | | | is earlier than |
| | | | | production date; |
| | | | | labeled date is |
| | | | | later than |
| | | | | production date |

In comparison, it is instance one, i.e. printing date on the production date, that is the right practice.

There can be various reasons behind the difference between the labeled date and the production date. For example, as mentioned in the Background of the Invention, one reason is that the manufacturer wishes to extend the time the product can be allowed in goods shelves. Another possible reason is that, for example, the packaging of a product of manufacturer A is produced by a manufacturer B, where the labeled date is printed on the packaging in advance. If on a certain date, the actual amount of product of the manufacturer A exceeds the amount of packaging prepared for that date, the manufacturer can use the packaging on which the next date is printed.

The inventors find that, if the actual date of when the labeled date of the product is printed can be verified, it will help to prevent illegal manufacturers from printing the labeled date in advance.

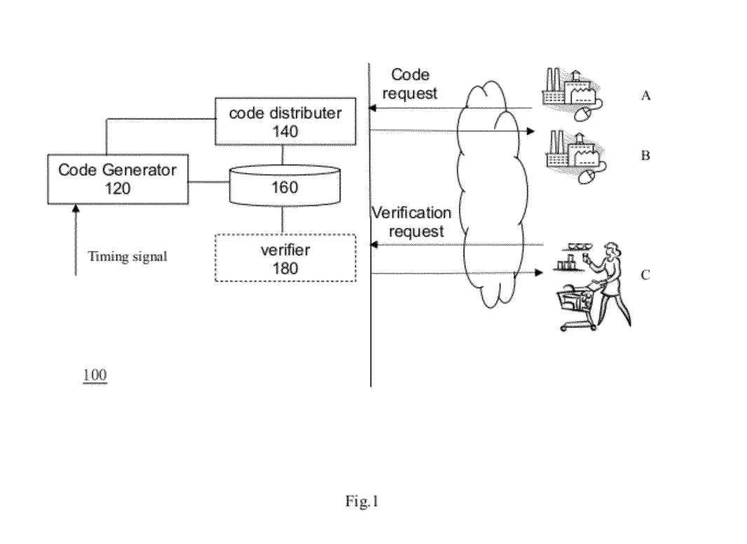

Referring to FIG. 1, an embodiment of the system of the invention for verifying labeled date on packaging of product is described.

The system 100 shown in FIG. 1 includes a code generation device 120, a code distribution device 140 and a storage device 160.

The functions and embodiments of the above devices will be described in more detail below.

The code generation device 120 is configured to generate one or more random codes, the one or more random codes being associated with the date when the one or more random codes are generated.

The function of the code generation device 120 is generating random codes associated with dates. According to one embodiment of the invention, the code generation device 120 can generate random codes periodically at a fixed time of each day, for example, at 00:00 o'clock every day. A random code generated in such a way has specific relationship with the date when the random code is generated. For example, the code generation device 120 generates a random code “8857” on January 1 of year 2010. Then that random code “8857” is said to be in association with the date “January 1 of 2010”. For example, for the random codes “4924” and “6627”, both of them are in association with the date “January 2 of year 2010”.

As to the format of random code that can be generated by the code generation device 120, there is no limitation for the invention. The random code generated by the code generation device 120 can include digit, alphabet, character, graph or any arbitrary combination including digit, alphabet, character, graph, for example, “abc”, “@#$” or “s1b#”.

According to one embodiment of the invent invention, the function of the code generation device 120 can be implemented by using a random number generator. There exist various algorithms for generating random numbers. In the embodiment of the invention, the random number generator can adopt various algorithms to generate random numbers as random codes.

As the invention is not focused on various random number generators and their algorithms, of which the details are not difficult for those skill in the art to understand, detailed description on random number generators and their algorithms is omitted here.

According to one embodiment of the invention, the system 100 can further include a timer device (not shown) configured to send a timing signal to the code generation device 120 at a predefined time of hour. For example, the timer device can, according to predefined settings, send a timing signal Ts to the code generation device 120 at 00:00 o'clock everyday.

For example, at 00:00 o'clock of January 1, 1 of 2010, the timing signal Ts sent by the timer device is received by the code generation device 120. The code generation device 120 (e.g. a random number generator) is triggered by the timing signal Ts and generates a random code “8857”.

In practice, the code generation device 120 can generate multiple random codes in series by the triggering of one timing signal Ts; or the code generation device 120 can generate multiple random codes respectively by the triggering of multiple timing signals Ts.

The storage device 160 is configured to store the one or more random codes generated by the code generation device 120 with their respectively associated dates. Since the date(s) of the one or more random codes generated by the code generation device 120 is in association with the date(s) when the one or more random codes are generated, it can be said that the random codes generated by the code generation device 120 are stored together with their corresponding dates of generation in a one-to-one fashion.

According to one embodiment of the invention, the storage device can be a database, in which each record at least contains one random code of the one or more random codes and the date that is associated with the one random code. In other words, a database is used in the storage device 160 to store the random codes generated by the code generation device 120 and the dates when the codes are generated, and each database record at least contains one random code and the date when the random code is generated.

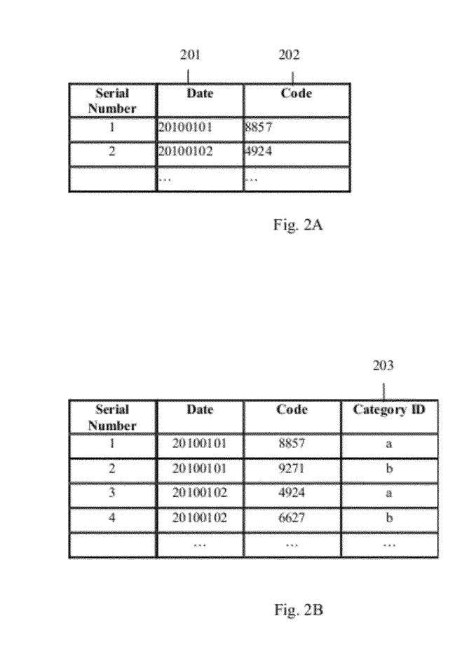

FIG. 2A and FIG. 2B illustratively present the database record in accordance with one embodiment of the invention. The record of the database shown in FIG. 2A contains a “date” attribute 201 and a “code” attribute 202, where the attribute “code” 202 denotes a random code generated by the code generation device 120 and the attribute “date” denote the generation date of the random code. There are only two records shown in FIG. 2A. The first record contains a date “20100101” and a random code “8857”, meaning that the random code “8857” is generated by the code generation device 120 on Jan. 1, 2010. The second record contains a date “20100102” and a random code “4924”, meaning that the random code “4924” is generated by the code generation device 120 on Jan. 2, 2010. FIG. 2A also shows that the code generation device 120 generates one random code separately on January 1 and January 2 of 2010.

FIG. 2B shows the database record in accordance with another embodiment of the invention. In addition to an attribute “date” 201 and an attribute “code” 202, the records shown in FIG. 2B also contains an attribute “category ID” (category identification) 203. There are four records shown in FIG. 2B. The first record contains a date “20100101”, a random code “8857” and a category ID “a”. The date, random code and category ID of the second record are “20100101”, “9271” and “b”, respectively. The date, random code and category ID of the third record are “20100102”, “4924” and “1234101”, respectively. The date, random code and category ID of the fourth record are “20100102”, “6672” and “b”, respectively. The above records show that the code generation device 120 generates two random codes respectively on January 1 and January 2 of 2010.

It can be seen from FIG. 2B that the code generation device 120 generates two random codes “8857” and “9271” that correspond to the date January 1 of 2010. The random codes “8857” and “9271” respectively correspond to the category IDs “a” and “b”. In practical applications, the category ID 203 can be assigned different meanings.

For example, the category ID 203 can be used to represent manufacturer, e.g., “a” representing manufacturer “A” and “b” representing manufacturer “B”. Under such a circumstance, “8857” can denote the random code generated for the manufacturer A and “9271” can denote the random code generated for the manufacturer B.

As another example, the category ID 203 can be used to represent different products, e.g., “a” representing fresh milk and “b” representing bread. Under such a circumstance, “8857” can denote the random code generated for the particular product of fresh milk, or the random code generated for one or more manufacturers A of fresh milk, and “9271” can denote the random code generated for the particular product of bread, or the random code generated for one or more bread manufacturers A.

The code distribution device 140 is configured to distribute the one or more random codes 202, generated by the code generation device 120, as the code to be printed on product packaging along with the labeling date of the product.

In implementing the invention, the random codes 202 will be distributed to manufacturer's receiving device connected to the system 100 via networks (e.g., computer or labeled date printing system).

For example, manufacturers that want to adopt the system 100 of the invention can register with the system 100. The system 100 will take registered manufacturers as the target to which random codes 202 are distributed. In registering, Manufacturers can require the system 100 to provide customized services. For example, the manufacturers A can require the system 100 to separately provide random codes for the manufacturer A. In that case, the code generation device 120 of the system 100 can separately generate the random code for the manufacturer A and the random code is only distributed to the manufacturer A. The manufacturer A can also agree to share a random code with other manufacturers (e.g. B). In that case, the system 100 can distribute the random code that it has generated to the computer of the manufacturer B as well as the computer of the manufacturer A.

The system 100 can fully comply with the requirements of individual manufacturers, as put forward when making registration, to decide the number of random codes that need to be generated and the corresponding manufacturer of each of the random codes. Specific details can be readily designed and practiced by those skilled in the art and thus are unnecessary to be provided here.

The system 100 can directly distribute a random code to the receiving device of the registered manufacturer that corresponds to the random code, after the code generation device 120 generates it. It needs to note that the time of distribution already contains information on the date when the random code is generated.

As shown by the arrow in the upper right corner of FIG. 1, in accordance with one embodiment of the invention, the system 100 can receive the code request sent by the registered manufacturer (A, B) via networks and then distribute the random code to the receiving device of the registered manufacturer.

For example, the registered manufacturer A sends a code request to the system 100 via networks for obtaining the random code generated on January 1 of 2010. The code distribution device 140 responds the request by sending the random code “8857” generated on January 1 of 2010 to the receiving device of the manufacturer A. It needs to be noted that the code request shall include the date information of “January 1 of 2010”. The date when the request is sent can be the default date when the random code is generated.

After receiving the random code “8857” sent by the code distribution device 140, the manufacturer A will print labeled date “Jan. 1, 2010” on packaging of its product, and print the code “8857” at the same time. For example, the manufacturer A can print the following content on package of product: “production date: 20100101; verification code: 8857”. That is to show the labeled date “20100101” on the packaging is not printed in advance.

By printing the code “8857” on packaging of product, the manufacturer A can indicate that the labeled date on the packaging is not printed in advance. However, that itself can not prove that the labeled date is not printed in advance. For example, if another producer B forged a code “1234” and print the following content on package of product in the same way: “production date: 20100101; verification code: 1234”, the consumer can also be unable to validate whether the labeled date “20100101” is printed in advance or not.

Therefore, a corresponding verification mechanism can be provided.

According to one embodiment of the invention, the system 100 further contains a verification device 180 which is configured to validate the relationship between the code and labeled date on packaging of product based on the random code 202 and associated date 201 stored in the storage device 160.

Validating the relationship between the code and labeled date on packaging of product is virtually verifying whether the relationship between the code and labeled date on packaging of product is consistent with the relationship between the random code 202 and date 201 stored in one-to-one correspondence in the storage device 160. If in the storage device 160 there exist a random code 202 that is same as the code on packaging of product and a date 201 in connection with the random code 202 that is same as the labeled date, then it can be determined that the labeled date was not printed in advance.

As shown by the arrow in the lower right corner of in FIG. 1, the system 100 including the verification device of 180 can receive the query request such as from a consumer C or quality inspector to validate the relationship between the code and labeled date on packaging of product.

For example, the consumer C buys a bag of milk in the supermarket and sees “production date: 20100101; verification code: 8857” printed on the milk bag. In order to validate whether the date is printed in advance, the consumer can connect to the system 100 through the network, then send out a query request.

The system 100 can, in a user interface, prompt the consumer C to enter the verification code on the milk bag. The consumer enters the code “8857”.

The verification device 180 of the system 100 receives the entered code “8857” and queries the storage device 160 (e.g., the database shown in FIG. 2A) to see whether or not there is any record with random code same as the code “8857”.

If the verification device 180 does not find any the code “8857” in the storage device 160, an indication denoting that the code does not exist is returned. If the verification device 180 finds the code “8857” in the storage device 160, then a date corresponding to the code “8857” is returned.

If the content of the storage device 160 is as shown in FIG. 2A, then the date “20100101” is returned by the system 100. The date matches with the labeled date of “production date: 20100101” on the milk bag. Therefore, the consumer C can be assured that the labeled date on the milk bag is not printed in advance.

If the system returns the indication denoting that the code does not exist, or returns a date other than “20100101”, the consumer C can become aware that there is a problem with the labeled date on the milk bag.

The verification device 180 can provide queries in other ways.

According to one embodiment of the invention, the system 100 can, in a user interface, prompt the consumer C to enter the date and verification code which is found on the milk bag. The verification device 180 uses the consumer C entered labeled date and code to query the storage device 160 (e.g., the database shown in FIG. 2A) to see whether or not there is any record including the date and the random code, and outputs the query result.

If the query result is “Yes”, the consumer C can be assured that the labeled date is not printed in advance.

It is to be noted that the block of dotted lines in the left of FIG. 1 denotes that, as long as the verification device 180 is able to access the storage device 160, it can be separately configured outside the system 100 including the code generation device 120, the code distribution device 140 and the storage device 160 without influencing integrity of functions of the system 100.

According to a same inventive concept, the invention also provides a method for verifying labeled date on packaging of product.

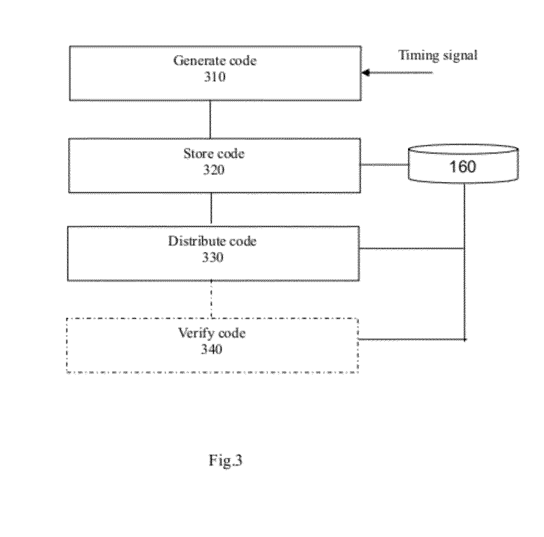

FIG. 3 shows the flow chart of the method for verifying labeled date on packaging of product according to one embodiment of the invention.

As shown in FIG. 3, the process of the method starts with Step 310.

In Step 310, one or more random codes are generated. The one or more random codes are associated with the date when the one or more random codes are generated.

The one or more random codes can be generated periodically or regularly (for example, at zero o'clock everyday). According to one embodiment of the invention, Step 310 can be executed in response to a timing signal sent out by a preset timer. The random code can have various forms, and the random number generated by a random number generator can be used as the random number.

In Step 320, the one or more random codes and the associated date are stored in a storage device.

According to one embodiment of the invention, a database is used for storing the one or more random codes, each database record including at least one random code and the generation date of the random code.

According to one embodiment of the invention, a type mark is further stored in correspondence with the one or more random codes in the storage device (e.g., database). Such type marks can represent different manufacturers, and can also represent different types of products.

In Step 330, the one or more random codes are distributed as the code to be printed along with labeled date on packaging of product.

As mentioned in the above description on the system 100, there is no need to have strict order between Step 320 and Step 330.

For example, Step 330 can be executed directly after Step 310. Namely, the random code can be directly distributed to a receiving device (e.g., manufacturer's computer) after generation of the random code, so that the manufacturer can also print the random code while print the labeled date for verification by the consumer.

The receiving device can be pre-designated (e.g., computer of registered manufacturer).

According to one embodiment of the invention, Step 330 can be executed, i.e., a random code is returned, in response to the request from the receiving device (e.g., computer of registered manufacturer), where the request includes a date, and the returned random code is the random code that is stored in association with the date. The date included in the request can be a explicitly designated date, or it can implicitly be the date when the request is issued.

After the storage device stores random codes and associated dates, Step 340 can be executed anytime in response to a verification request. Step 340 validates the relationship between the code and labeled date on packaging of product based on the random code and associated date stored in the storage device.

According to one embodiment of the invention, Step 340 can include the following: receiving a query request that includes a code which is on packaging of product, and querying the storage device (such as database) to check whether there is any random code in the storage device that is same as the code which is on the packaging of product. If the code which is on the packaging of product is found in the storage device, then returning an indication that there is no random code in the storage device that is the same as the code on the packaging of product; If the code which is on the packaging of product is found in the storage device, then returning the date which is in association with the random code in the storage device.

The query request can be sent by the consumer C that has bought the product. Based on the returned query result, the consumer can compare the returned date with the date on the packaging of product to see whether they match and thereby make corresponding judgment.

According to another embodiment of the invention, Step 340 can include the following: receiving a query request that includes a code and a labeled date on packaging of product, querying the storage device (such as database) to check whether there are any random code and associated date that are respectively same as the code and the labeled date, and returning the query result. For example, the query result can be “No record including the date and the random code exists” or “A record including the date and the random code exists”. If it is the latter one, the consumer sending the query request can judge that the labeled date of packaging of product is problematic.

Application of the system and method for the invention can result in remarkable technical effects and social benefits. Industry organizations and quality supervising departments can also use the inventive system in order to regulate the behavior of manufacturers and protect consumers' interest. For the credibility of their own products, manufacturers also have the incentive to use the inventive system More specifically, before printing a production date, manufacturers can obtain a random code generated on the date of production prior to printing product date and print the random code along with the production date on packaging of product for verification by consumers. Thus, situation of the instance 2 illustrated in Table 1 of the above specification can be prevented from happening. If a situation of the instance 2 really occurs, it is impossible for the manufacturer to obtain a random code generated after 2010.01.01; so, even if the labeled date is 2010.01.02, consumers can be able to find that the labeled date is problematic if they verify the date through the inventive system.

The above has described the method for verifying labeled date on packaging of product according to embodiments of the present invention. Because the system for verifying labeled date on packaging of product according to embodiments of the present invention has been described in detail in the above, the description of the method omits the content that repeats or can be derived from the description of the method for verifying labeled date on packaging of product according to embodiments of the present invention.

It should be noted that the above depiction is only exemplary, not intended for limiting the present invention. In other embodiments of the present invention, the method can have more, or less, or different steps, and numbering the steps is only for making the depiction more concise and much clearer, but not for stringently limiting the sequence between each steps, and the sequence of steps can be different from the depiction. For example, in some embodiments, the above one or more optional steps can be omitted. Specific embodiment of each step can be different from the depiction. All these variations fall within the spirit and scope of the present invention.

The present invention can be implemented by hardware, software, or combination of hardware and software. The present invention can be implemented in a computer system in a collective or distributive manner, where in the distributed manner, different parts are distributed in a plurality of interconnected computer systems. Any computer system or other apparatus suitable for implementing the method as depicted herein is suitable. A typical combination of hardware and software can be a universal computer system with a computer program which, when being loaded and executed, controls the computer system to implement the method of the present invention and constitute the apparatus of the present invention.

The present invention can also be embodied in a computer program product which includes all features capable of implementing the method as depicted herein and can implement the method when loaded to the computer system.

The present invention has been specifically illustrated and explained with reference to the preferred embodiments. The skilled in the art should understand various changes thereto in form and details can be made without departing from the spirit and scope of the present invention.

1. A system for verifying a labeled date on packaging of a product, the system comprising:
a code generation device configured to generate one or more random codes associated with a date when the one or more random codes are generated;
a storage device configured to store the one or more random codes and the date associated therewith; and
a code distribution device configured to distribute the one or more random codes as a code to be printed with the labeled date on the packaging of the product.

2. The system of claim 1, wherein said storage device comprises a database containing the one or more random codes and the date associated therewith.

3. The system of claim 1, wherein said code distribution device is configured to distribute the random code in response to receiving a request from the receiving device, wherein said request contains a date which matches the associated date of the random code.

4. The system of claim 1, further comprising:
a verification device configured to validate the relationship between the code printed with the labeled date on the packaging of the product, wherein the verification is based on the random code and the associated date stored in the storage device.

5. The system of claim 4, wherein the verification device is configured to receive the code on the packaging of the product, query the storage device to check if the code matches the one or more random codes, and return an indication denoting that the code does not exist if there is no match or return the date in association with the random code that matches the code.

6. The system of claim 4, wherein the verification device is configured to:
receive the code and the label date on the packaging of the product;
query the storage device for a match with the one or more random codes and dates associated therewith; and
return the query result.

7. The system of claim 1, further comprising a timer device configured to send a timing signal, wherein the code generation device is triggered by the timer signal to generate the one or more random codes.

8. The system of claim 1, wherein the code generation device is the one or more random codes generator.

9. A method for verifying a labeled date on packaging of a product, the method comprising the steps of:
generating one or more random codes associated with a date when the one or more random codes are generated;
storing the one or more random codes and the date associated therewith; and
distributing the one or more random codes as a code to be printed with labeled date on the packaging of the product.

10. The method of claim 9, wherein the one or more random codes and the date associated therewith are stored in a database.

11. The method of claim 9, wherein the random code is distributed in response to receiving a request from the receiving device, wherein said request contains a date which matches the associated date of the random code.

12. The method of claim 9, further comprising:
validating the relationship between a code and the labeled date on the packaging of the product based on the random code and date associated therewith.

13. The method of claim 12, wherein the validating step comprises:
receiving a query request that includes a code on the packaging of the product;
querying the storage device to check if the code matches the one or more random codes; and
returning an indication denoting that the code does not exist if there is no match or returning the date in association with the random code that matches the code.

14. The method of claim 12, wherein the validating step further comprises:
receiving the code and the labeled date on the packaging of the product, querying the storage device for a match with the one or more random codes and the date associated therewith, and returning the query result.

15. The method of claim 9, wherein said generating the one or more random codes comprises generating the one or more random codes at a triggering of a timing signal.

16. A computer readable article of manufacture tangibly embodying non-transitory computer readable instructions which, when executed, cause a computer to carry out the steps of a method for verifying a labeled date on packaging of a product, the method comprising the steps of:
generating one or more random codes associated with a date when the one or more random codes are generated;
storing the one or more random codes and the date associated therewith; and
distributing the one or more random codes as a code to be printed with labeled date on the packaging of the product.
